(19) United States
(12) Patent Application Publication
(10) Pub. No.: US 2021/0044789 A1
(43) Pub. Date: Feb. 11, 2021

(54) ELECTRONIC VISUAL HEADSET WITH VISION CORRECTION

(71) Applicant: Anton Zavoyskikh, Los Angeles, CA (US)

(72) Inventor: Anton Zavoyskikh, Los Angeles, CA (US)

(21) Appl. No.: 17/078,035

(22) Filed: Oct. 22, 2020

Related U.S. Application Data
(62) Division of application No. 16/359,347, filed on Mar. 20, 2019.

(51) Int. Cl. H04N 13/122; H04N 13/324; H04N 13/327; H04N 13/344; G02B 27/01; G02C 7/08

(52) U.S. Cl. CPC H04N 13/122; H04N 13/324; H04N 13/327; H04N 13/344; G02B 27/0172; G02B 2027/014; G02B 27/0179; G02B 2027/0178; G02B 2027/0187; G02B 2027/0138; G02B 2027/0134; G02C 7/081

(57) ABSTRACT

An electronic visual headset useful for purposes of augmented reality, virtual reality, vision correction, and/or vision enhancement. The invention corrects vision impairments such as near-sightedness or far-sightedness. One embodiment uses phakometry cameras to measure the eyes' lenses. An alternative embodiment uses dynamic calibration with test images. The display may be digitally manipulated for correction of night vision, color blindness, or tunnel vision. It may also be enhanced with infrared vision, zoom, etc. Corneal eye-tracking devices and variable-magnification lenses coordinate to resolve vergence-accommodation conflict. An image of the user's eyes is displayed on the exterior of the headset.

### 1. FIELD OF THE INVENTION

This invention is in the field of optics, particularly for the display of three-dimensional imagery for virtual reality or augmented reality purposes.

### 2. BACKGROUND OF THE INVENTION

Since this invention pertains to vision correction and enhancement, I must review the basics of eye anatomy and the vision process as necessary to understand this invention. The cornea is the clear outer layer of the eye. It has a fixed shape. The cornea protects the underlying iris, the colored annulus. The pupil is a hole in the iris. Behind the pupil is the lens. The lens changes curvature dynamically to focus incoming light. The proper curvature of the lens varies with the distance to the focal plane. The degree of curvature of the lens is known in the art as “accommodation”. Most people's lenses do not work perfectly. The ideal eye focuses images onto the retina, the rear surface of the inner eye, where specialized vision-processing cells and nerves transmit the image to the brain. However, near-sighted or far-sighted eyes improperly focus images either in front of or behind the retina, resulting in blurry vision.

Three-dimensional vision results from the brain's processing of two images taken from slightly different perspectives by the two eyes. For the left and right eyes to look at the same object 102, the eyes must rotate horizontally. The eyes' lines of sight are nearly parallel or divergent for objects at infinity, and increasingly “crossed” or convergent for near objects. The angle between the eyes' lines of sight is referred to in the art as “vergence”.

Vergence and accommodation are involuntary reflexes. They occur simultaneously and, in normal vision, they agree with each other. That is, if the two eyes are converged in such a way as to simultaneously look at an object ten meters away, then each lens will be accommodated to a focal plane ten meters away.

This invention combines devices and techniques in several inter-related fields: vision correction, vision enhancement, augmented reality, and virtual reality. The invention as claimed today is a divisional application of U.S. patent application Ser. No. 16/359,347. The present claims are directed primarily to the features described as “Vision correction” below, and secondarily to certain “Vision enhancement” features.

By “vision correction”, I mean the use of optics to correct impairments in the eye's ability to see normally. The most common vision impairments are near-sightedness and far-sightedness. Color blindness and tunnel vision are other impairments that can be addressed with optics or other specially engineered devices such as the present invention. Some impairments, such as glaucoma or nerve damage, cannot be addressed with external devices.

By “vision enhancement”, I mean the use of optics, graphics, or other technology to present images not visible to the normal naked eye. Examples of vision enhancement are magnification and minification, night vision, heat detection, etc.

By “augmented reality” (AR) I mean the presentation of electronic images superimposed upon a view of the immediate real-world environment. Examples of augmented reality devices are Google Glass and the game Pokémon Go. Pokémon Go uses a smart phone's camera to display the local environment, and then projects an artificial character on the same screen to create the illusion that the character is in the environment. Google Glass uses a Near Eye Display (NED) with text or images presented immediately in front of the eyes on transparent lenses.

By “virtual reality” (VR) I mean the presentation of a simulated or broadcast environment to the eyes. To see VR, the user wears a headset that blocks out the real world and presents a NED of an environment, which may be related or unrelated to the user's real-world surroundings.

### 3. DESCRIPTION OF RELATED TECHNOLOGY

Today's AR and VR technology is very advanced, but has some basic imperfections. The three most important problems to be addressed are (1) incompatibility with prescription eyeglasses, (2) an effect called vergence-accommodation conflict, and (3) obstruction of the eyes.

### A. Vision Correction

AR glasses and VR headsets are worn over the face where prescription eyeglasses would normally belong. Therefore, someone who normally wears eyeglasses can not use VR or AR with the vision-correction assistance of his glasses. Most AR/VR devices assume that the wearer has perfect eyes, leading to blurry displays for most naked-eye users. This frustrating issue is discussed in the 2017 CNET blog “The Future is Coming, but I Can't See It” by Scott Stein (see citations) demonstrating that this problem is still by-and-large unaddressed in the prior art.

A small number of non-commercialized prior art references are devoted to the challenge of providing near-sighted/far-sighted vision correction in AR/VR headsets. The best solution discussed so far is a cumbersome calibration process. Before using the headset, the user takes a vision test to determine his corrective prescription (or perhaps multiple prescriptions for near, medium, and far vision). Information about the user's prescription is programmed into the device or relayed to the device with, say, a smartphone app.

Carlos Mastrangelo is developing a pair of glasses with dynamic vision correction using a calibration method. Mastrangelo's device is described in the 2017 Smithsonian article “These ‘Smart Glasses’ Adjust to your Vision Automatically”, by Emily Matchar (see citations). Samuel Miller et al. of Magic Leap, Inc. have described a pair of AR glasses that use a calibration method to provide vision correction at multiple ranges. This technology is described in at least two patent applications (see citations).

If the calibration process takes prescriptive readings at more than one range, like near, medium, and far, then the device must be able to discern how far ahead the user is looking. Mastrangelo's solution is to use a simple infra-red emitter/detector system, which measures the distance from the glasses to the nearest solid object in the glasses' line of sight. This tracking method has clear limitations. The user might not be looking at the nearest solid object, which could for instance be a wall on the other side of the room. As the user shifts his eyes, the glasses will be unaware that the user is not looking straight ahead at the object being detected by the infra-red signal.

The Magic Leap solution is more advanced. It makes use of eye-tracking technology. A small camera mounted inside the device scans the outer surface of each eye to detect its line of sight. The two cameras detect “vergence” (convergence or divergence) between the left and right eyes, or the deviation from parallel of the two lines of sight. Vergence is controlled involuntarily by the brain to help the two eyes look directly at the same object. Eye-tracking technology is also well-known in the AR/VR field (though still nascent in development) to detect where within the environment the user is looking.

A third vision-corrective AR system is described by Wang et al, 2017 (see citations). Wang discloses the use of two lenses for each eye. One lens is used to focus on the appropriate focal plane within the environment. The other lens provides additional vision correction as required by the user, who may be near-sighted or far-sighted. The Wang system does not describe a calibration method.

The use of a calibration system for vision correction has its drawbacks. It is inconvenient and expensive for a user to get an optometric exam before using the device. Calibration is only as effective as the most recent prescription, which changes over the years. If a headset is calibrated to one user, then it is not easily interchangeable to other users unless they also have their prescriptions available.

What is needed is an alternate system for providing dynamic near-sighted/far-sighted vision correction (with or without an AR/VR display). That is one major aim of this invention, and my solution is described in detail below.

### B. Vergence/Accommodation Conflict

The next major shortcoming of AR/VR displays is the effect of vergence/accommodation conflict. The illusion of depth is created by offsetting images in the two eyes' fields of view. As the amount of offset between the images varies, the vergence between the eyes varies. Meanwhile, the images are displayed on a screen that is a fixed distance from the eyes. To focus on the screen, the lenses must maintain constant accommodation at the screen's focal plane. When the eyes are forced into an artificial state of changing vergence but fixed accommodation, the brain gets confused. This can lead to poor imaging, disorientation, eye fatigue, headaches, or vertigo.

The only known solution to the vergence/accommodation conflict is the varifocal display, as described by Nitish Padmanaban et al. in “Optimizing VR with Gaze-Continent Focus Displays” (see citation). The varifocal display uses a cell phone as the display screen. The phone is secured in a VR headset and then moved back and forth with a motor to present slightly different focal lengths.

The present invention presents an alternative to the varifocal display to address the vergence/accommodation conflict in near-eye displays.

### C. Obstruction of the Eyes

AR/VR glasses have the potential to greatly obstruct the eyes. They often involve components such as cameras, scanners, and projectors. A near-eye display is often a mirrored surface or an opaque electronic screen, such as an OLED or LCD display. In that case, the user's eyes are not visible to others at all. A third major objective of this invention is to provide electronically-enhanced eyeglasses that allow the user to maintain clear eye contact during face-to-face conversation.

### D. Integration

A further objective of the present invention is to integrate numerous options for vision correction, vision enhancement, and AR or VR capability. There are several well-known types of specialty glasses dedicated to one function: to magnify, expand peripheral vision, correct for color blindness, enhance night vision, or enable infra-red or ultra-violet vision. Existing products only perform one of these functions. This invention takes advantage of miniaturized image-processing technology to combine all these capabilities in one device.

### 4. SUMMARY OF THE INVENTION

This invention is a pair of eyeglasses equipped with electronic components for vision correction, vision enhancement, and AR/VR functions. There are multiple optional features for the invention, which shall be described separately in the detailed description below. Each embodiment has one or more of the following features.

A series of external cameras looks outward to the environment. These cameras look in generally the same direction as the user's gaze, though some of them may be peripheral.

A series of internal cameras looks inward at the user's eyes. Some of the internal cameras are for eye-tracking purposes; they follow each eye's line of sight. Other cameras are phakometric; they measure the focal curvature of the eye's lens, aka the accommodation. Still other cameras take visual images of the eyes and surrounding region of the face.

An image processor receives data from all cameras. By processing the external cameras' Field Of View (FOV) and the eyes' lines of sight, the processor determines the user's intended Region Of Interest (ROI) in three-dimensional space.

The user's ROI is displayed to the user with a high-definition display, such as a DLP or OLED screen or with retinal projection.

Variable-magnification lenses are situated between the user's eyes and the display. These lenses present virtual images of the display at the intended focal plane, thus avoiding vergence-accommodation conflict.

The processor then analyzes the user's accommodation to determine if the user's lenses are focused correctly. The optics further adjust focus according to the user's visual needs. This allows for dynamic vision correction, as determined by the real-time accommodation of each eye's lens.

The processor can manipulate the displayed image in a variety of ways. It can magnify the scene. It can minify the scene, which allows for greater peripheral vision. It can enhance brightness for night vision. It can enhance color to correct color blindness. It can alter wavelengths of light to enable infra-red or ultra-violet vision.

The exterior of the eyeglass lenses may also be a high-resolution (e.g. DLP or OLED) display. Internal cameras take real-time images of the user's eyes, which are presented on the exterior displays. This creates the illusion to nearby people that they are seeing right through the glasses to the user's eyes.

### 5. BRIEF DESCRIPTION OF THE DRAWINGS

FIG. 1 depicts eye vergence and a visual region of interest. None of the subject matter in this figure is claimed.

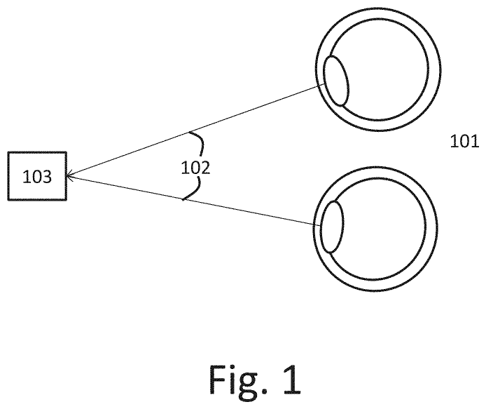

FIG. 2 shows an overview of the invention, and illustrates direct retinal projection.

FIG. 3 illustrates indirect retinal projection.

FIGS. 4a and 4b illustrate the variable-magnification lens in the form of a rigid lens that moves toward or away from the eyes to adjust focus.

FIGS. 5a and 5b illustrate the the variable-magnification lens in the form of a stationary, flexible lens that changes shape to adjust focus.

FIG. 6 is a top view of the user and his environment. This figure illustrates the process of image zoom-out to expand peripheral vision.

FIGS. 7a and 7b demonstrate the exterior eye display. FIG. 7a shows a user wearing opaque glasses. FIG. 7b shows the user wearing the same opaque glasses, this time with a real-time display of his eyes on the exterior surface of the eyeglass lenses, to create the illusion of direct eye contact.

FIGS. 8a and 8b show methods to secure real-time images of the user's eyes. FIG. 8a shows a direct scan method, with a camera aimed directly at the eyes. FIG. 8b shows an indirect scan method, with a camera aimed at a reflection of the eyes.

FIGS. 9a and 9b illustrate measurement of the eyes' lenses with a phakometry camera, for purposes of vision correction. FIG. 9a depicts the response of the phakometry camera when the eye has a flattened lens. FIG. 9b depicts the response of the phakometry camera when the eye has a rounded lens.

FIG. 10 is a side view of FIG. 4. FIG. 10 clarifies the workings of the optics and shows relevant distances.

### 6. DETAILED DESCRIPTION OF THE PREFERRED EMBODIMENTS

### A. Resolving the Vergence/Accommodation Conflict

I first present the features of the device that resolve the vergence/accommodation conflict. This technology is useful in any AR/VR device, whether it is displaying a real or simulated environment.

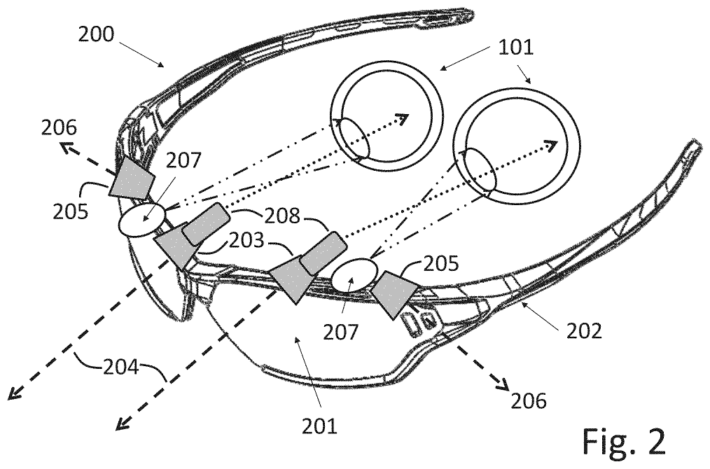

FIG. 2 shows the preferred embodiment of the enhanced eyeglasses device 200 and several of its main components. Screens 201 (left and right) are supported by frame 202. The screens 201 are opaque, so the user does not see through them. Rather, display means are used to present images to the left and right eyes. The display means may present the user's real-world environment, a simulated environment, or a combination of real and simulated environments. There are three mutually exclusive preferred embodiments for the display means.

The first embodiment of the display means is shown in FIG. 2. The interior of each screen 201 is a neutral opaque material such as black plastic (not visible in the figure). Retinal projectors 208 project images directly into each eye, through the pupil, to be focused on the retina.

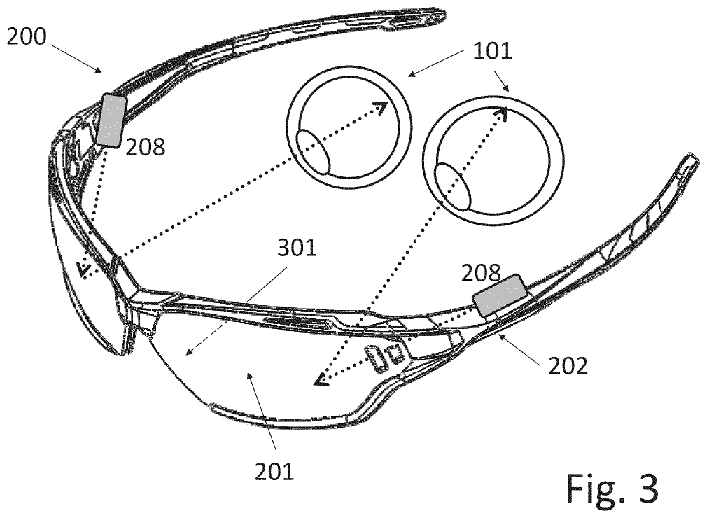

The second embodiment of the display means is shown in FIG. 3. The interior surface of each screen 201 is a mirrored surface 301. Left and right retinal projectors 208 are positioned near the temples on frame 202. Projectors 208 project images onto each mirrored surface. The images are then reflected into each eye. This process is called indirect retinal projection. The advantage of indirect projection is to increase the distance between the image and the eye; human eyes have trouble focusing on objects less than a few inches away.

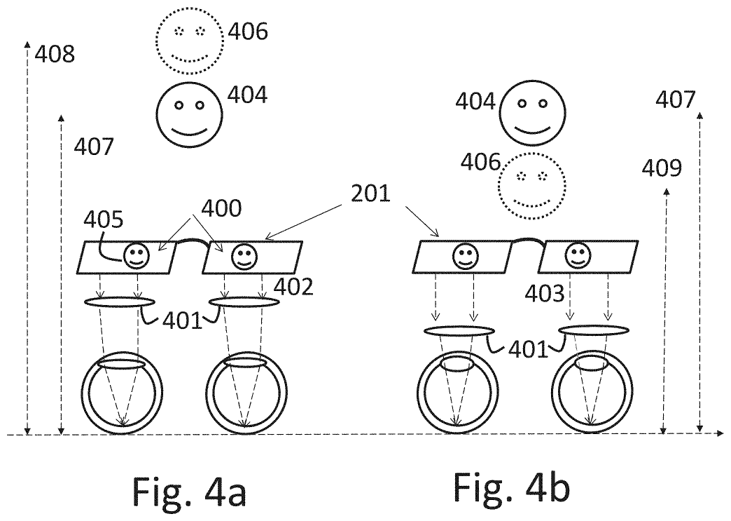

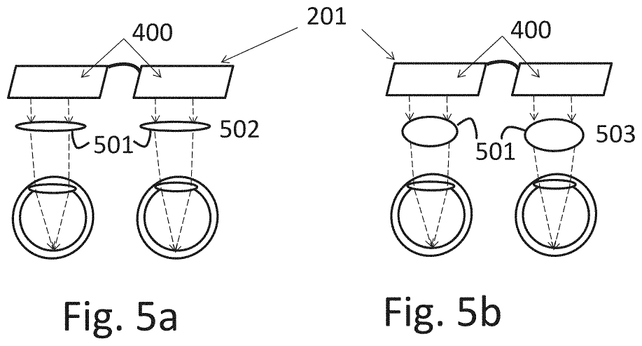

The third embodiment of the display means is shown in FIGS. 4a, 4b, 5a, and 5b. The interior surface of each screen 201 is a display screen 400 such as an LCD, DLP, or OLED screen.

The device has left and right eye scanners 207, shown in FIG. 2. Each scanner comprises an eye-tracking sensor. An eye-tracking sensor has an eye-tracking projector, an eye-tracking detector, and a processor (not shown). The eye-tracking projector projects narrow beams of infrared light of a first frequency onto the cornea. The eye-tracking detector detects the location of the pupil and the reflection of the infrared beam from the cornea. By analyzing the relative locations of the pupil and the corneal reflection, the processor determines the direction in which the eye is looking. This technique is known as pupil-center/corneal-reflection (PCCR) eye-tracking, and it is well-known in AR/VR technology and other fields.

The processor uses information from the PCCR eye-tracking sensors to determine the line of sight 102 for each eye 101. It then calculates the point of intersection of the two lines of sight to determine the user's visual region of interest 103 in the displayed environment. The region of interest is a small region of three-dimensional space. The linear distance from the eyes to the region of interest is the gaze distance. Display-focusing means—optics under the control of a computer processor—then adjust the display means to focus at the gaze distance.

In order to resolve the vergence/accommodation conflict, the device must now present virtual images of the display that align with the region of interest. This is accomplished with variable-magnification lenses. The variable-magnification lenses are converging lenses, acting on the same principle as magnifying lenses or glasses for far-sightedness. These lenses are shown in FIGS. 4a, 4b, 5a, and 5b. In these figures, the lenses are shown in conjunction with the display screen embodiment of the display means. The lenses work in similar fashion in conjunction with the retinal projector embodiments of the display means.

As shown in FIGS. 4a and 4b, the user's visual region of interest in the (real or simulated) environment is 404. The gaze distance 407 is the distance from the eye to the region of interest. A displayed image 405 of the region of interest is presented on each display screen 400. Each variable-magnification lens 401 creates a virtual image 406 of the displayed image 405. The virtual image distance is the distance from the eye to the virtual image 406. The virtual image distance is 408 in FIGS. 4a and 409 in FIG. 4b.

In FIGS. 4a and 4b, the variable-magnification lenses are rigid lenses 401, with fixed radius of curvature. They vary the virtual image distance by moving closer or further from the eyes. The variable-magnification lenses 401 are adjusted mechanically or piezo-electrically, under the control of a computer processor programmed with the lens equation and other necessary parameters.

In FIG. 4a, the rigid lenses are at a first position 402. The resulting first virtual image distance 408 is too large. In FIG. 4b, the rigid lenses are at a second position 403. The resulting second virtual image distance 409 is too small. At some point in between, the virtual image distance would equal the gaze distance 407, thereby aligning the virtual image 406 precisely with the region of interest 404. At this point, the eyes' vergence (determined by the gaze distance) and accommodation (determined by the virtual image distance) would agree, thus resolving vergence/accommodation conflict.

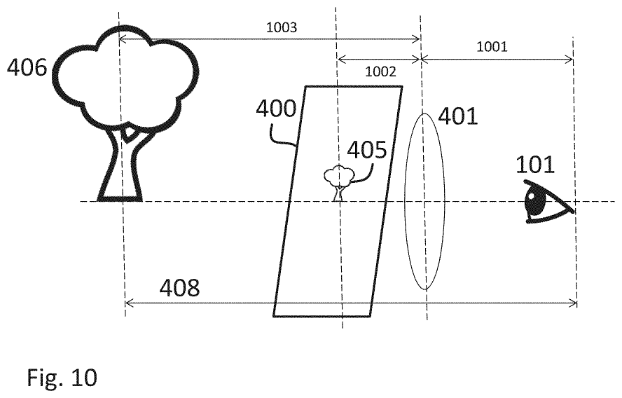

The optics of FIG. 4 are clarified in FIG. 10, a side view of one eye. The variable-magnification lens 401 is situated between the eye 101 and the screen 400. The displayed image 405 on the screen is a representation of a real or simulated 3D environment, focused at the eyes' gaze distance. The variable-magnification lens 401 creates a virtual image 406 of the displayed image 405. (It's important to understand that 405 and 406 are both images; neither is a tangible object, and 406 is an image of an image). Lens 401 performs according to the lens equation

$$\frac{1}{i} + \frac{1}{o} = \frac{1}{f} .$$

Here, the image distance i is represented by 1002, the distance between the lens 401 and the displayed image 405. The object distance o is represented by distance 1003, the distance between the lens 401 and the virtual image 406. The lens's focal distance f is represented by distance 1001. By varying focal distance 1001 and/or image distance 1002, the system adjusts object distance 1003. Distance 408, shown here as approximately the sum of distances 1001 and 1003, is the “virtual image distance” from the eye to the virtual image 406, as shown in FIG. 4.

The ratio o:i is called the magnification of lens 401. Despite common usage of that word, magnification does not simply refer to producing a “larger” image in the eye's field of view. By adjusting the virtual image distance 408, the variable-magnification lens 401 can make virtual image 406 appear as a nearby small object or a distant large object (as opposed to displayed image 405, which is extremely small and extremely close). This accomplishes the necessary 3D effect of positioning virtual image 406 at the appropriate depth.

A critical reader might raise the objection here that virtual image 406 will still really be a two-dimensional “virtual screen” of screen 400 in its entirety. Technically, that is true. However, in practice this doesn't matter. A human eye has a very small region of visual interest. When you look at one word on a page, you will notice that you have trouble discerning anything more than one word away. Biologically, that is because visual acuity is concentrated on a small region of the retina called the fovea. The fovea's field of view only covers a few nanosteradians, something that could be handled by a small number of pixels on screen 400. Everything beyond that foveated field of view can be blurry without troubling the eye. In fact, recall that displayed image 405 is focused at the user's gaze distance, so that image may already be blurred outside of the visual region of interest.

FIGS. 5a and 5b summarize a similar process for a different kind of variable-magnification lens. The process is similar to that shown in FIGS. 4a and 4b, though the objects and images are not shown in FIGS. 5a and 5b. Here, the variable-magnification lenses 501 are deformable lenses such as adjustable gel pouches. They have variable radius of curvature and are situated at a fixed position relative to the eyes and the display screen 400. The deformable lenses vary the virtual image distance by changing their radius of curvature. Adjustment of the radius of curvature may be accomplished by mechanical or piezoelectric means, under control of the processor. In FIG. 5a, deformable lenses 501 assume a first shape 502 that is relatively flat and has a large radius of curvature. In FIG. 5b, deformable lenses 501 assume a second shape 503 that is relatively rounded and has a small radius of curvature. As the deformable lenses alter their radius of curvature, the virtual image moves nearer or further from the eyes. The processor determines the correct shape of the lenses to match the virtual image distance (and hence the accommodation) to the gaze distance (and hence the eyes' vergence).

Another potential objection to this system (referring to FIG. 10) is that the lens's focal distance 1001 might not exactly match the distance from lens 401 to the fovea of eye 101, i.e. that the image might not exactly focus in the eye. Because object distance 1002 is very small, the system usually operates under the condition that o<<i . The lens equation above is equivalent to

$$f = \frac{i o}{i + o} .$$

In the limit o<<i, this equation yields the result that f≈o. Therefore, if lens 401 is placed roughly halfway between eye 101 and screen 400, the focus will always be close. Nevertheless, one further corrective step might be required to sharply focus virtual image 406 in the eye. This could be achieved, for example, by combining the lens's variable position, as illustrated in FIG. 4, with its variable shape, as illustrated in FIG. 5.

### B. Vision Correction

Next, I describe the technology for vision correction. The components and processes above assume that the user has normal vision, whether unassisted or with contact lenses. If a person is near-sighted or far-sighted and does not wear contact lenses, the display described above (or any standard AR/VR headset) will appear unfocused. That is because the biological lens in eye 101 has improper curvature, and brings images into focus either in front of or behind the retina. Vision-correction lenses are required to compensate for the biological lenses' imperfections. In its best mode of use, the present invention uses the aforementioned variable-magnification lenses to serve as vision-correction lenses. However, in an alternative embodiment the vision-correction lenses are distinct from the variable-magnification lenses.

There are two alternative methods to determine the necessary vision correction. The first method is calibration. Calibration takes place in a controlled environment as the user wears the glasses, usually for the first time. In the calibration process, the glasses present a number of images, some within the near field of vision, some far, and some at an intermediate distance. For each image, the user adjusts the focal power of the vision-correction lenses so that the image appears clear. The preferred focal correction is stored in memory as the glasses' corrective prescription. If preferred, the processor can interpolate corrective powers between the measurements taken.

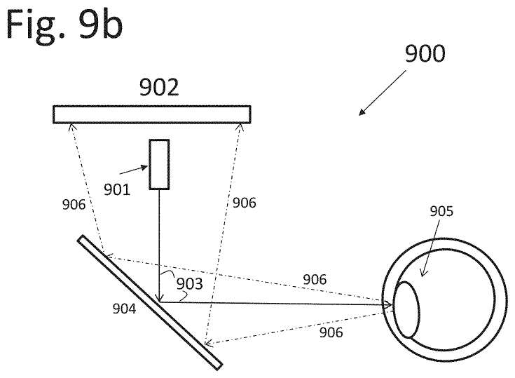

The second vision correction method involves real-time scanning of the eyes' lenses. In the present invention, each eye scanner comprises a phakometry camera 900 as shown in FIGS. 9a and 9b. A phakometry camera operates similarly to a PCCR scanner, but it measures the curvature of the lens. Each phakometry camera 900 has a phakometry projector 901 and a phakometry detector 902. The phakometry camera shares the common processor with the rest of the invention. Each phakometry projector 901 projects a narrow beam 903 of infrared light of a second frequency, through the pupil onto the eye's lens 905. The beam 903 may be projected directly onto the lens or, as shown in the figures, redirected with at least one mirror 904. The reflection 906 of the beam from the eye's lens 905 is dispersed, and the degree of dispersal depends on the curvature of the lens. The reflection 906 strikes the phakometry detector 902. Reflection 906 may travel directly from the eye's lens to the phakometry detector 902. Alternatively, as shown in the figures, the reflection 906 may be redirected with at least one mirror 904.

The phakometry detector detects the dispersal of the beam reflected from the lens, i.e. the area and intensity with which reflection 906 strikes detector 902. The processor then calculates the eye's focal distance as a function of this dispersal. For instance, FIG. 9a depicts the eye's lens 905 in a flattened configuration for focusing on distant objects. The reflection 906 is deflected very little from the incoming beam 903. Therefore, reflection 906 strikes detector 902 in a concentrated region with high intensity. In FIG. 9b, the eye's lens 905 is shown in a rounded configuration for focusing on nearby objects. The reflection 906 is deflected at a greater angle from the incoming beam 903. The reflection 906 then strikes the detector 902 in a widespread region with low intensity. The processor would return a higher focal distance in FIG. 9a than in 9b.

The calculated focal distance as determined by lens accommodation is then compared to the intended focal distance (gaze distance) as determined by the eyes' vergence, i.e. the location of the visual region of interest. The device now has a real-time optometric prescription for each eye.

Phakometry cameras are well-known in optometric diagnostic equipment, but they are not disclosed in any known VR/AR headsets. A phakometry camera offers multiple advantages over a calibrated system. It obviates the inconvenient step of getting a vision test before using the device. It uses real-time information, unlike a prescription that changes over time. It works for everyone who wears the device, making the headset completely transferable.

After the prescription information is obtained, whether by calibration or real-time phakometry, the vision-correction lenses are adjusted to focus images clearly in the user's eyes. The vision-correction lenses are adjusted mechanically or piezo-electrically, under control of the processor.

### C. Vision Enhancement

The technology described above for vision correction and for resolving the vergence/accommodation conflict is applicable to any near-eye display, whether it be a real or simulated environment. In this section, I will discuss the invention's capability to enhance vision of real-w orld surroundings. The basic idea is to capture images of the surroundings and then present them to the user through the retinal projectors 208 or the near-eye displays 400. At first glance, it might seem nonsensical to use virtual reality glasses to view the real world. However, when the real world is converted to a digital image, it is much more amenable to manipulation.

Left and right forward exterior cameras 203 have forward lines of sight 204 to capture images of the environment in front of the user. Left and right peripheral exterior cameras 205, with peripheral lines of sight 206, capture images of the environment to the side or rear of the user. The display means (e.g. the retinal projector 208 or display screen 400) then display the images captured by the forward exterior cameras, and optionally by the peripheral exterior cameras. The cameras shown in the figures are represented by symbolic shapes for purposes of demonstration. In actual practice, they may be small, embedded in the eyeglass frame, and not blatantly visible on the device. In fact, the cameras and the display means may be on different devices. If the end user is watching the display in one location, the device with cameras may be in a different environment (e.g. worn by another person or mounted on a machine), allowing for simulation of presence in that remote location. For remote viewing, the two devices must maintain a wireless connection for transmitting data back and forth.

Focus of the exterior cameras is determined by the user's visual region of interest (ROI). In other words, if the eyes are converging on a box six feet away from the cameras, the cameras focus on the box, and the display means present the environment focused on that box. The image in the display means is now subject to digital enhancement.

A first example of digital enhancement is zoom. The display means can zoom in to the scene presented to the user, simulating the experience that the user is nearer the region of interest. This results in larger details, the tradeoff being a narrower field of vision. Zoom-in can be achieved by a combination of well-known optical or digital means.

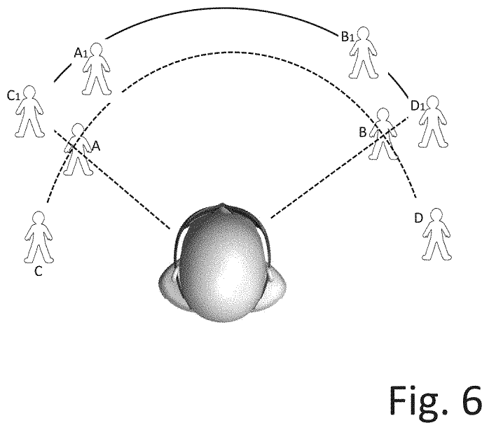

A second example of digital enhancement is peripheral vision. The scene presented to the user is “zoomed out” to present a wider field of view. This gives the user a view of the environment beside him or even behind him, so the peripheral cameras 205 are necessary for this application. As a tradeoff, zooming out necessarily results in smaller details, simulating the experience that the user is getting farther from the region of interest. FIG. 6 illustrates the minification process. The user is seen from above. Figures A and B are at the limits of the user's unaided cone of visibility. Normal vision has a field of view of nearly 180° horizontally and 150° vertically, with very poor acuity at the periphery. Some people experience “tunnel vision” and have a narrower field of view. Figures C and D are outside the user's unaided cone of visibility. They are invisible to his unaided eyes, but are within the peripheral cameras' sight. Upon the minification command, an expanded field of view is presented within the cone of visibility. Transformed images C₁ and D₁ are now within the user's cone of visibility. Transformed images A₁ and B₁ are closer to the center of the user's field of view, for higher visual acuity than at the periphery. Upon minification, the vertical field of view is likewise expanded. The user may adjust the field of view freely. Alternatively, the calibration procedure measures peripheral vision. During calibration, the glasses present images at an increasing angle from the central field of vision until the user reports that he can no longer see them. The glasses can then be set to automatically minify the environment to bring a full 180° display within the user's actual range of vision.

A third example of digital enhancement is night vision. Some people's eyes do not allow enough light to see well in the dark. In a dark environment, the digital display can increase the brightness and contrast of the scene for improved vision.

A fourth example of digital enhancement is infrared/ultraviolet vision. The forward and peripheral cameras are sensitive to electromagnetic radiation beyond the visible portion of the spectrum. The frequency of light in the display can be digitally increased in order to bring infrared radiation into the visible range, so that the user can “see” patterns of infrared radiation. This is valuable for night-time body heat detection, as people and other animals radiate infrared energy. Alternatively, the frequency of light in the display can be digitally decreased in order to bring ultraviolet radiation into the visible range, so that the user can “see” patterns of ultraviolet radiation. This is valuable for detecting the efficacy of shade and sunscreen.

Fluorescence is a related phenomenon in which special substances, including some bodily fluids, absorb ultraviolet light and reflect it as longer-wavelength visible light. Fluorescent imaging often provides valuable forensic evidence at crime or disaster scenes. The processing of fluorescent imaging is enhanced with color filters. In one embodiment, the present invention includes an external ultraviolet light source mounted on the frame. The retinal projector 208 or internal display screen 400 then offers digitized color filters for immediate visual processing of the scene.

A fifth example of digital enhancement is color blindness correction. During calibration, the glasses present a color-vision test image, which displays a pattern to a person with normal color vision. If the user cannot discern the pattern, he can adjust color intensities until the pattern becomes clear. The glasses remember this “prescription”, and then automatically adjust color intensities to enhance the user's color perception in the long term.

### D. External Eye Display

The present invention, like all pairs of virtual reality glasses, is opaque. This prevents the user from making direct face contact with people in his immediate surroundings. However, one important application for this device is vision correction and/or enhancement in his own real-world surroundings, so the user will regularly interact with people around him. It can be disconcerting to those other people to carry on a conversation without eye contact.

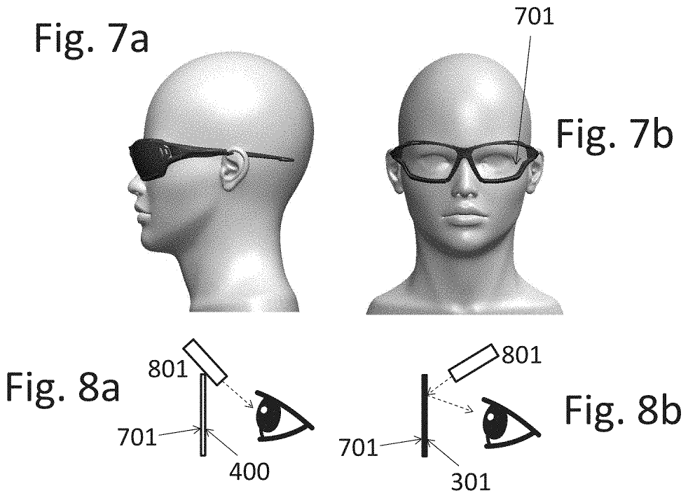

The solution is to display a real-time image of the user's eyes on the external surface of the glasses. The external surface of each screen 201 is an external display screen 701. This is a high-resolution pixelated display like the internal display screens. FIG. 7a shows a user wearing the glasses with the external display screen off; the glasses appear as opaque sunglasses. In FIG. 7b, the external display screen 701 is on. Now an image of the user's eye region is displayed on the external display screen, making the glasses appear transparent.

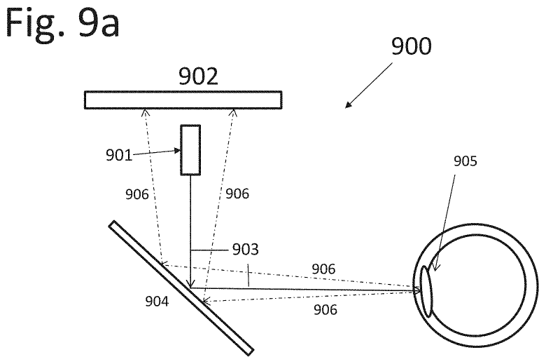

The image of the eye region is obtained with a plurality of eye cameras 801. The eye cameras may be mounted directly on the frames facing the eyes, as shown in FIG. 8a. Alternatively, if the interiors of the screens are mirrored surfaces 301, the eye cameras can be offset from the frames, facing the mirrored surfaces to capture reflections of the eyes, as shown in FIG. 8b. The images of the eyes captured by the plurality of eye cameras are sent to the external eye displays 701.

I claim:

1. An electronic visual headset, comprising:
left and right corneal eye-tracking sensors to determine a direction of gaze for each eye;
a processor, which receives as input the direction of gaze for each eye and returns as output an intended focal distance;
first focusing means comprising a variable-focus lens for making optometric corrections for each eye;
left and right phakometry cameras to measure an actual focal distance of each eye's lens;
whereby the processor receives as further input the intended focal distance and the actual focal distance of each eye's lens and returns as output an optometric prescription for each eye;
whereupon the processor adjusts the first focusing means as prescribed by the optometric prescriptions, thus providing vision correction for near-sighted or far-sighted eyes.

2. The electronic visual headset of claim 1, further comprising
left and right stereoscopic images of a three-dimensional environment;
left and right screens, each screen having an interior surface;
electronic display means for displaying images on the interior surface of each screen;
said stereoscopic images displayed on the electronic display means on the interior surface of each screen.

3. The electronic visual headset of claim 2, further comprising
left and right forward exterior cameras for capturing images of a forward environment;
left and right peripheral exterior cameras for capturing images of a peripheral environment;
said stereoscopic images formed from the set consisting of the images of the forward environment and the images of the peripheral environment.

4. The electronic visual headset of claim 3, further comprising
zoom controls for zooming the stereoscopic images within the electronic display means.

5. The electronic visual headset of claim 4, further comprising
pixels in the electronic display means;
image-enhancement controls for adjusting the pixels;
said image-enhancement controls selected from the set consisting of saturation controls, brightness controls, and wavelength controls.

6. The electronic visual headset of claim 5, further comprising
color-calibrating images displayed on the electronic display means on the interior surface of each screen;
specifically comprising saturation controls for adjusting the color-calibrating images to an optimal color setting;
whereby the processor receives as further input the optimal color setting, and returns as output a color-vision prescription for each eye;
whereupon the processor adjusts the saturation controls as prescribed by the color-vision prescriptions, thus providing color-vision correction.
